(19) United States
(12) Patent Application Publication
(10) Pub. No.: US 2022/0238252 A1
(43) Pub. Date: Jul. 28, 2022

(54) Additives, Corresponding Uses, Insulation Systems, and Electric Machines

(71) Applicant: Siemens Aktiengesellschaft, München (DE)

(72) Inventors: Jürgen Huber, Erlangen (DE); Dieter Schirm, Breitengüßbach (DE); Matthias Übler, Ursensollen (DE)

(73) Assignee: Siemens Aktiengesellschaft, München (DE)

(21) Appl. No.: 17/614,683

(22) PCT Filed: Apr. 8, 2020
(86) PCT No.: PCT/EP2020/059990

§ 371 Date: Nov. 29, 2021

(30) Foreign Application Priority Data
May 28, 2019 (DE) 10 2019 207 771.4

(51) Int. Cl. H01B 3/40; H02K 3/30; C08K 5/105

(52) U.S. Cl. CPC H01B 3/40; C08K 5/12; C08K 5/105; H02K 3/30

(57) ABSTRACT

Various embodiments of the teachings herein include a solid insulation material based on a resin containing epoxy groups for production of an anhydride-free insulation system by means of VPI. The material comprises: an anhydride-free curing catalyst; and an additive for improving distribution of the anhydride-free curing catalyst, wherein the additive comprises a phenyl carboxylate. The additive is present in an amount based on the epoxy groups in the resin containing epoxy groups which is present in the impregnating agent of at least 0.1% in stoichiometric terms.

### CROSS-REFERENCE TO RELATED APPLICATIONS

This application is a U.S. National Stage Application of International Application No. PCT/EP2020/059990 filed Apr. 8, 2020, which designates the United States of America, and claims priority to DE Application No. 10 2019 207 771.4 filed May 28, 2019, the contents of which are hereby incorporated by reference in their entirety.

### TECHNICAL FIELD

The present disclosure relates to insulation systems. Various embodiments include additives for use in a method of producing an insulation system by the VPI (vacuum pressure impregnation) process, in which a solid insulation material is impregnated with an impregnating resin containing epoxy groups at elevated temperature and under pressure.

### BACKGROUND

Rotating electrical machines include an electrical winding within a laminated core, for example a stator winding. This is composed of electrical conductors optionally already surrounded by a solid insulation material, and solid insulation materials as main insulation with respect to the laminated core. Without further measures, there is no impervious bond between the laminated core, the conductors and the main insulation, and so gaps and cavities remain. These regions are filled with air under standard atmospheric conditions. This is inadequate in the case of applications in the mid- and/or high-voltage sector, i.e., for example, in the case of generators and/or electrical drives, since partial electrical discharges in the cavities and gaps would destroy the insulation system within a very short period of time. The resulting electrical breakdown means the failure of the electrical machine.

The VPI process has to date been performed successfully with acid anhydrides and epoxy resins as the main constituents of the impregnating agent for vacuum pressure impregnation of a solid insulation material which is, for example, a mica tape with curing catalyst deposited therein, at impregnation temperature about 70° C. and under reduced pressure, i.e. a pressure less than 1 bar, especially less than 0.5 bar. The winding composed of a solid insulation material is therefore typically impregnated with the impregnating agent in a VPI process. The impregnating agent used is a curable impregnating resin and/or a corresponding varnish. The solid insulation materials here may be porous in order to increase the absorption of impregnating resin. Examples of these are mica tapes, insulation papers and/or nonwovens.

The solid insulation material may be implemented, for example, in the form of mica tapes. The mica tapes have a tape adhesive and a curing catalyst dissolved and/or ultrafinely distributed therein. The curing catalyst is therefore also referred to as “deposited curing catalyst” in the solid insulation material because it is stored within the solid insulation material until the incoming impregnating agent—which is liquid at the time—leaches the curing catalyst out of the solid insulation material. The tape adhesive serves here to bind mica paper and carrier materials such as films and/or glass weaves, whereas the proportion of “tape accelerator”, as the deposited curing catalyst is also called, mediates the gelation of the mobile impregnating resin and, after the gelation, initiates and accelerates the thermal curing of the impregnated winding made of solid insulation material. For this purpose, the impregnating resin that penetrates into the winding during the VPI process dissolves the tape adhesive/deposited curing catalyst combination in the solid insulation material, or leaches it out of the pores, for example, and brings about distribution of the deposited curing catalyst in the impregnating agent.

Since the curing catalyst deposited is part of the solid insulation material, there is generally inhomogeneity in the distribution of the curing catalyst in the impregnating resin to be cured during the VPI process, because this results in regions in the impregnating agent having high and low concentration of curing catalyst deposited or present. Acid anhydrides distributed in the impregnating agent have been used to date, which firstly act as curing agent (addition polymerization when present in a stoichiometric ratio to the impregnating resin) for the impregnating resin and secondly also lower the viscosity of the impregnating agent because they are highly viscous, and so no problem has been presented by the homogeneity of the mixture comprising the deposited curing catalyst in the case of the acid anhydride-containing impregnating agents that have been customary to date.

It is now known, however, that the acid anhydrides should be replaced for reasons predominantly of toxicity, and, in the acid anhydride-free formulations known to date, for example from DE 102014219844.5; DE 102014221715.6; DE 102015205328.8, EP 3227893 A1 and DE 102015204885.3, for production of such insulation systems, the compositions of the tape adhesives and deposited curing catalysts present in the solid insulation material on the one hand, and the impregnating resins with curing agents and optionally also curing catalysts that are present in the impregnating agent on the other hand, should be rebalanced with respect to one another. EP 3298611 A1 and WO 2017153113 A1 already disclose options for anhydride-free impregnating agents and corresponding tape adhesives and curing catalysts.

In spite of this, it has not been possible to date to provide a formulation for the VPI process comprising at least one solid insulation material and an impregnating agent that enables impregnation of the solid insulation material during the VPI process, said formulation being of sufficient homogeneity as to result in only few regions of the insulation system, if any, having low concentrations of curing catalysts. The problem in all these already known systems is that, while solid insulation material and impregnating agent are encountering one another in the VPI process, the result is an inhomogeneous distribution of the curing catalyst(s) that is generally not resolved sufficiently early, i.e. prior to gelation and consequent fixing of the mixture, such that the insulation system produced by the VPI process generally does not have sufficiently homogeneously distributed curing catalyst before the ultimate curing to give the thermoset. This leads to inhomogeneous curing and hence to an unsatisfactory insulation system.

### SUMMARY

The teachings of the present disclosure describe acid anhydride-free insulation systems producible by a VPI process, and more particularly additives which—present in the impregnating agent and/or in the solid insulation material—is suitable for a VPI process, contributing to the achievement of maximum curing of the compound to be polymerized. For example, some embodiments include a solid insulation material and/or impregnating agent based on a resin containing epoxy groups for production of an anhydride-free insulation system by means of VPI, containing an additive for better distribution of the anhydride-free curing catalyst(s), wherein the additive comprises one or more phenyl carboxylates and is present in an amount based on the epoxy groups in the resin containing epoxy groups which is present in the impregnating agent of at least 0.1% in stoichiometric terms.

In some embodiments, in the additive, at least one phenyl carboxylate is a compound of the following general structure I:

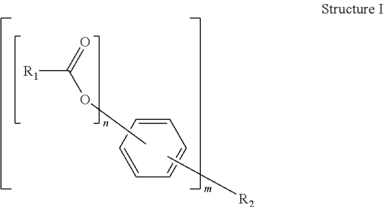

with n in the range from 1 to 5, n=1-5;
m in the range from 1 to 10, m=1-10;
R¹/R²=identical or different and
selected from the group of the following radicals
R¹=
H,
alkyl, linear or branched or cyclic with 1 to 12 carbon atoms, or
aryl having 6 to 12 carbon atoms, with or without side chains;
R²=
H,
alkyl, linear or branched or cyclic with 1 to 12 carbon atoms,
aryl having 6 to 12 carbon atoms
sulfonyl
sulfate
phosphonyl
phosphate or
siloxane, linear or branched or cyclic with 1 to 50 Si—O units.

In some embodiments, in the additive, at least one phenyl carboxylate is a compound of the following general structure II:

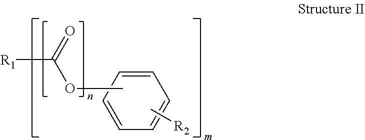

with
n in the range from 1 to 5, n=1-5;
m in the range from 1 to 10, m=1-10;
R¹/R²=identical or different and
selected from the group of the following radicals
R¹=
H,
alkyl, linear or branched or cyclic with 1 to 12 carbon atoms, or
aryl having 6 to 12 carbon atoms, with or without side chains;
R²═H,
alkyl, linear or branched or cyclic with 1 to 12 carbon atoms, or
aryl having 6 to 12 carbon atoms in the aromatic system, with or without side chains;
acyl.

In some embodiments, in the additive, at least one phenyl carboxylate is a compound of the following general structure III:

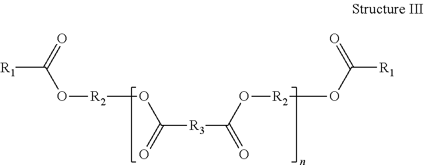

where
n is in the range from 1 to 10, n=1-10;
R¹/R²=identical or different and
selected from the group of the following radicals
=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
R³=absent or
alkyl, linear or branched or cyclic with 1 to 12 carbon atoms, or
aryl having 6 to 12 carbon atoms in the aromatic system;
alkylaryl having 2 to 4 phenyl units
biphenyl.

In some embodiments, in the additive, at least one phenyl carboxylate is a compound of the following general structure IV:

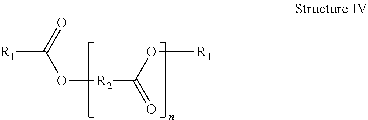

where
n is in the range from 1 to 10, n=1-10;
R¹=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl.

In some embodiments, in the additive, at least one phenyl carboxylate is a compound of the following general structure V:

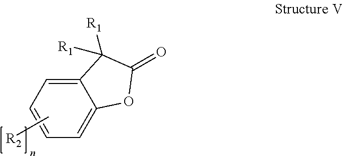

where
n is in the range from 1 to 10, n=1-10;
R¹=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
acyl
carboxyl.

In some embodiments, in the additive, at least one phenyl carboxylate is a compound of the following general structure VI:

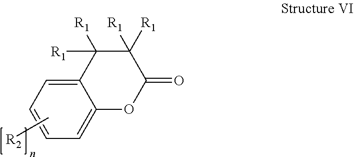

where n is in the range from 1 to 10, n=1-10; R¹=identical or different and selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
acyl
carboxyl.

In some embodiments, in the additive, at least one phenyl carboxylate is selected from the group of the following compounds:

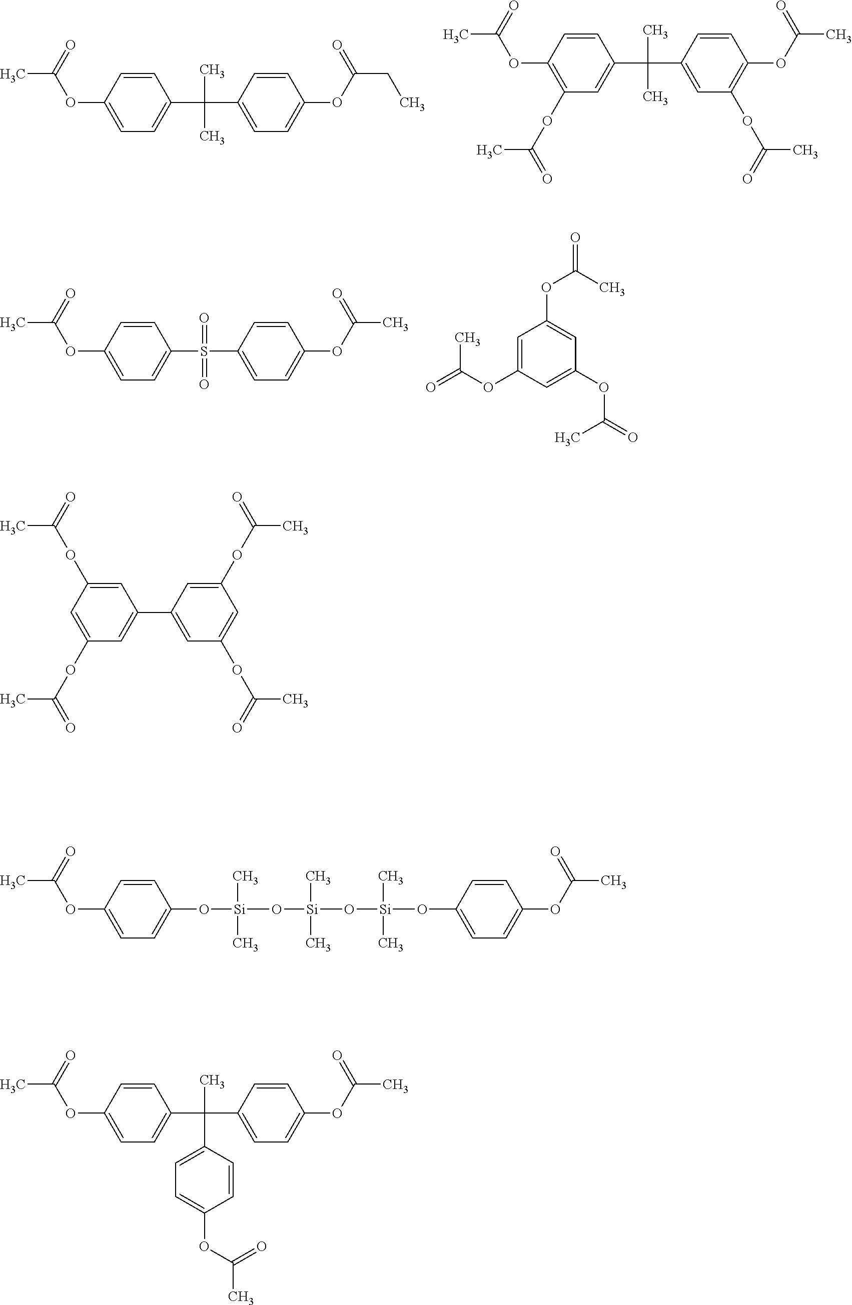

In some embodiments, in the additive, at least one phenyl carboxylate is selected from the group of the following compounds:

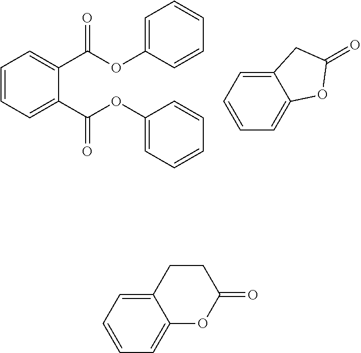

In some embodiments, the additive, based on the epoxy groups in the resin containing epoxy groups which is present in the impregnating agent, is present in an amount in the range from 10% to 100% in terms of stoichiometry.

In some embodiments, the additive, based on the epoxy groups in the resin containing epoxy groups which is present in the impregnating agent, is present in an amount in the range from 50% to 100% in terms of stoichiometry.

Some embodiments include the use of an additive as described herein in an impregnating agent for use in the VPI process for production of an insulation system of an electrical rotating machine.

Some embodiments include the use of an additive as described herein in a solid insulating material for use in the VPI process for production of an insulation system of an electrical rotating machine.

As another example, some embodiments include an insulation system for an electrical rotating machine comprising a solid insulation material and/or an impregnating agent with additive as described herein.

As another example, some embodiments include an electrical machine with an insulation system as described herein.

### BRIEF DESCRIPTION OF THE DRAWINGS

FIG. 1 shows the DSC scans of the crosslinking reaction of blends of a resin containing epoxy groups with rising stoichiometric proportions of a cyclic phenyl carboxylate, illustrated here by the example of dihydrocoumarin, at a high concentration of curing catalyst of 6.5% by weight of an anionic curing catalyst.

FIG. 2 shows the same DSC measurements of a blend of a resin containing epoxy groups with rising stoichiometric proportions of a cyclic phenyl carboxylate, again with dihydrocoumarin, at a low concentration of curing catalyst of 0.5% by weight of an anionic curing catalyst.

FIG. 3 shows a first table which summarizes how the enthalpies of reaction of mixtures of epoxy-containing impregnating agents and additive, here the cyclic phenyl carboxylate dihydrocoumarin, vary at high and low concentration of a curing catalyst with rising stoichiometric ratio of additive.

FIG. 4 shows the DSC scans of the crosslinking reaction of blends of a resin containing epoxy groups with rising stoichiometric proportions of a linear phenyl carboxylate, illustrated here by the example of bisphenol A acetate propionate, at a high concentration of curing catalyst of 6.5% by weight of an anionic curing catalyst.

FIG. 5 shows the same DSC measurements of a blend of a resin containing epoxy groups with rising stoichiometric proportions of a linear phenyl carboxylate, again with bisphenol A acetate propionate, at a low concentration of curing catalyst of 0.5% by weight of an anionic curing catalyst.

FIG. 6 shows a table which summarizes how the enthalpies of reaction of mixtures of epoxy-containing impregnating agents and additive, here bisphenol A acetate propionate, a linear phenyl carboxylate, vary at high and low concentration of a curing catalyst with rising stoichiometric ratio of additive.

### DETAILED DESCRIPTION

The teachings of the present disclosure provide a solid insulation material and/or impregnating agent based on a resin containing epoxy groups for production of an anhydride-free insulation system by means of VPI, containing an additive for better distribution of the anhydride-free curing catalyst(s), wherein the additive comprises
one or more phenyl carboxylates
and is present in an amount
based on the epoxy groups in the resin containing epoxy groups which is present in the impregnating agent of at least 0.1% in stoichiometric terms. The invention also provides for the use of an additive as described above in an impregnating agent and/or in a solid insulation material for use in the VPI process for production of an insulation system of an electrical rotating machine. Finally, the invention provides an insulation system comprising an additive as described above and an electrical machine comprising such an insulation system.

An insulation system for use in the VPI process for production of an electrical rotating machine generally comprises a solid insulation material that cures in the VPI process by vacuum pressure impregnation with an impregnating agent, which subsequently cures to give a thermoset. The additive promotes homogeneous distribution of the anhydride-free curing catalyst(s) during the VPI process and hence the complete curing even of inhomogeneously distributed curing catalyst concentration during the VPI process because it enhances the reactivity of the reactive groups of the compound to be polymerized.

In some embodiments, the solid insulation material comprises a carrier, such as a glass weave, a barrier material such as a mica, a tape adhesive for bonding of the barrier material to the carrier, and finally absorption media such as pores, warpages and/or pockets. What are provided therein are firstly the deposited curing catalyst—especially in tape adhesives free of oxirane groups—and at least one of the additives described herein.

The impregnating resin in the impregnating agent which is first sucked into the solid insulation material via reduced pressure in the VPI process and then is injected there under pressurization contains epoxy groups and is selected, for example, from the group of the following resins:
glycidyl ethers
bisphenol A diglycidyl ethers, bisphenol F diglycidyl ethers, epoxy novolaks, cycloaliphatic epoxy resins, aliphatic epoxy resins and/or epoxidized silicones/siloxanes

and any mixtures, copolymers and/or blends of the aforementioned resins.

An additive may add onto and may also copolymerize the epoxy groups of the resin. This modifies the resin because the reactivity of its reactive groups is increased and/or its sensitivity toward low curing catalyst concentrations is thus increased as a result. The additive, especially in the case of the acid anhydride-free impregnating agents, enables complete curing to give a thermoset even in regions that are low in curing catalyst through the modification of the resin based on epoxy resin, especially through modification of the epoxy groups. Examples of the additives that are used here with preference are phenyl carboxylates of the following structures:

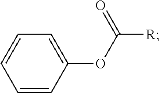

as parent structure for a linear phenyl carboxylate;

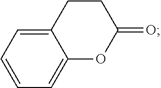 [SMILES: O=C1CCc2ccccc2O1]

as parent structure for a cyclic phenyl carboxylate, for example 6-membered cycle;

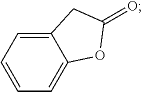

as parent structure for a cyclic phenyl carboxylate, five-membered cycle.

The addition onto the epoxy groups of the impregnation resin present proceeds, for example, according to the following scheme:

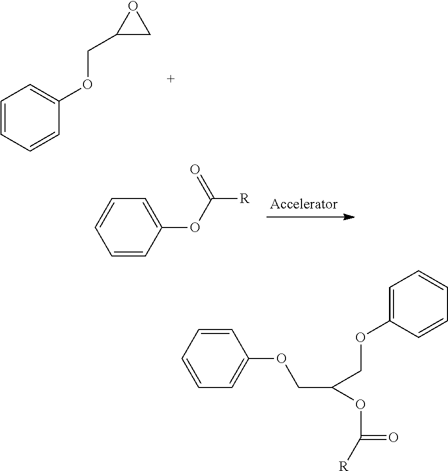

When linear phenyl carboxylates are used, as shown here, there is an addition reaction between an oxirane group and an ester group. In the case of a stoichiometric blend of oxirane functionality—or epoxy group—of the impregnating resin to ester functionality of the additive, therefore, there are at least two functionalities in each molecule for formation of a polymer chain to be achievable. For production of a thermoset material having three-dimensional crosslinking, there are at least three functionalities in each case.

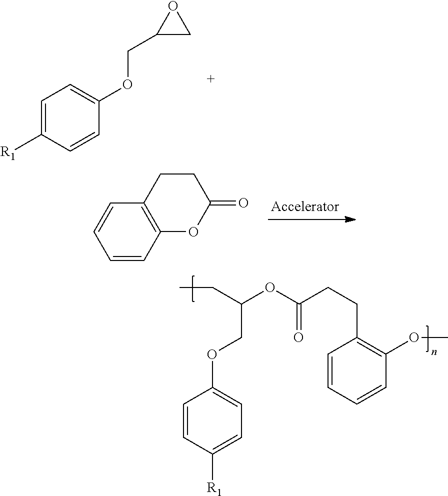

When cyclic phenyl carboxylates are used, there is a ring-opening polymerization between epoxy groups and ester groups. Here, in the case of a stoichiometric blend of epoxy groups and ester groups, it is already sufficient to make use of monofunctional reactants in each case in order to achieve formation of a polymer chain.

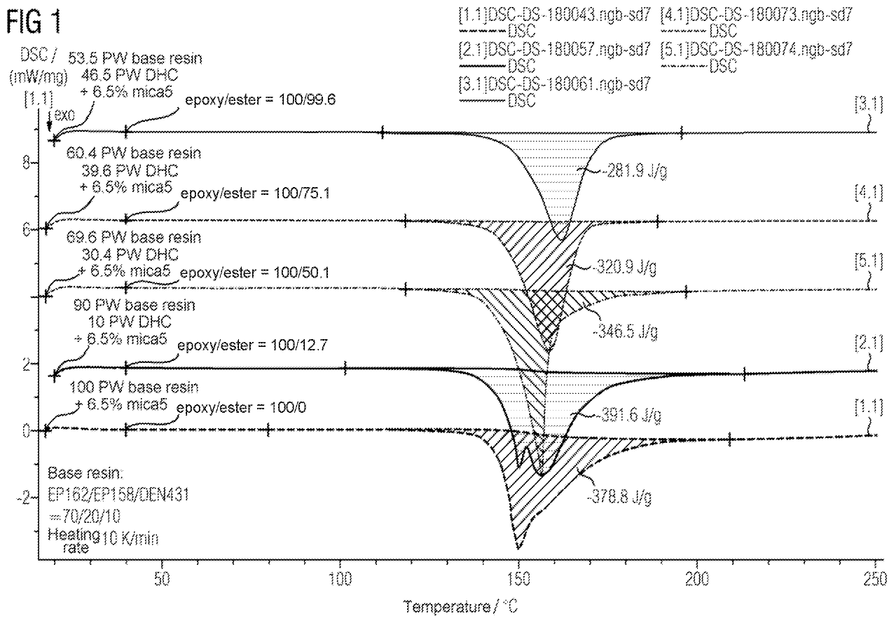

However, it is also possible to use the phenyl carboxylates in a nonstoichiometric ratio relative to the epoxy groups. Even in the case of substoichiometric use, they significantly affect reactivity toward impregnating agents with low curing catalyst concentrations, for example in the case of anionic curing catalysts and in the case of cationic curing catalysts. This is shown impressively in FIG. 1 by DSC measurements.

FIG. 1 shows the DSC scans of the crosslinking reaction of blends of a resin containing epoxy groups with rising stoichiometric proportions of a cyclic phenyl carboxylate, illustrated here by the example of dihydrocoumarin, at a high concentration of curing catalyst of 6.5% by weight of an anionic curing catalyst. The scan shown in FIG. 1 shows the evaluation of the exothermicities of reaction.

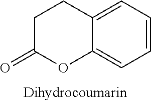 [SMILES: O=C1CCc2ccccc2O1]

The 5 graphs shown in FIG. 1 show the DSC scans—the “differential scanning calorimetry” measurements—DSC—i.e. the thermal analysis for measurement of the amount of heat released or absorbed by a sample that permit kinetic considerations of a chemical reaction, here the degree of crosslinking.

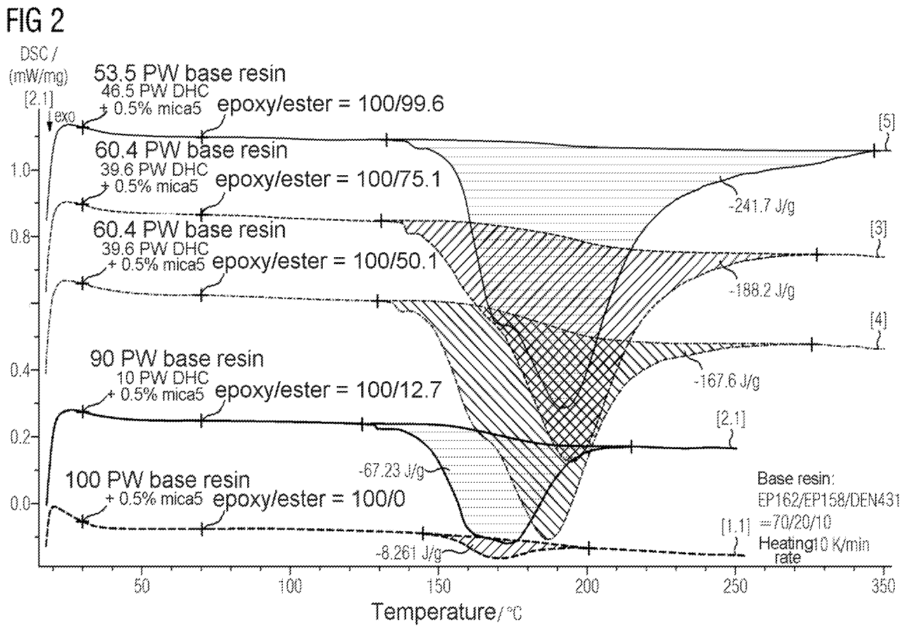

FIG. 2 shows the same DSC measurements of a blend of a resin containing epoxy groups with rising stoichiometric proportions of a cyclic phenyl carboxylate, again with dihydrocoumarin, at a low concentration of curing catalyst of 0.5% by weight of an anionic curing catalyst. The scan shown in FIG. 2 shows the evaluations of the exothermicities of reaction that are comparable to FIG. 1.

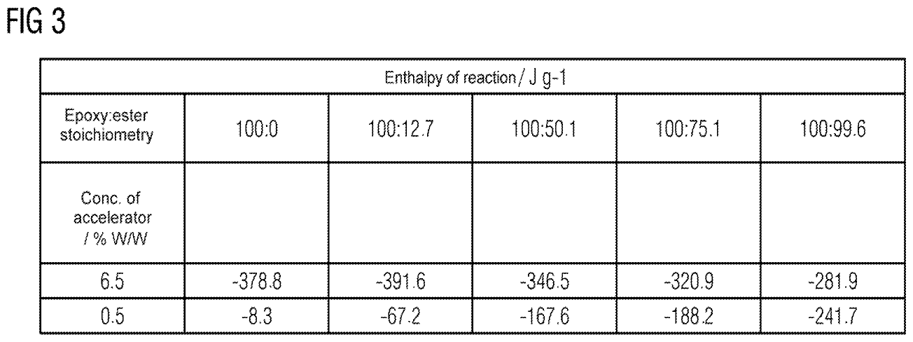

FIG. 3 summarizes the results from FIGS. 1 and 2, it being apparent that, even in the case of stoichiometric proportions of 50% phenyl carboxylate additive, it is possible to achieve a distinct rise in the exothermicity of reaction even in the case of small accelerator concentrations, and that there is a decrease in the difference in the exothermicities of reaction, especially in the comparison of high and low accelerator concentration.

FIG. 3 shows a first table which summarizes how the enthalpies of reaction of mixtures of epoxy-containing impregnating agents and additive, here the cyclic phenyl carboxylate dihydrocoumarin, vary at high and low concentration of a curing catalyst with rising stoichiometric ratio of additive.

It is also apparent, both in FIG. 2, the lowermost graph, and in FIG. 3, table, that there is no significant crosslinking, “enthalpy of reaction −8.3”, at the low accelerator concentration without addition of additive, i.e. lowermost line and second column from left. This is evidence that an additive according to the present invention, using the example here of the cyclic phenyl carboxylate, results in a modification of reactivity of the epoxy-containing impregnating agent in regions with low curing catalyst concentration.

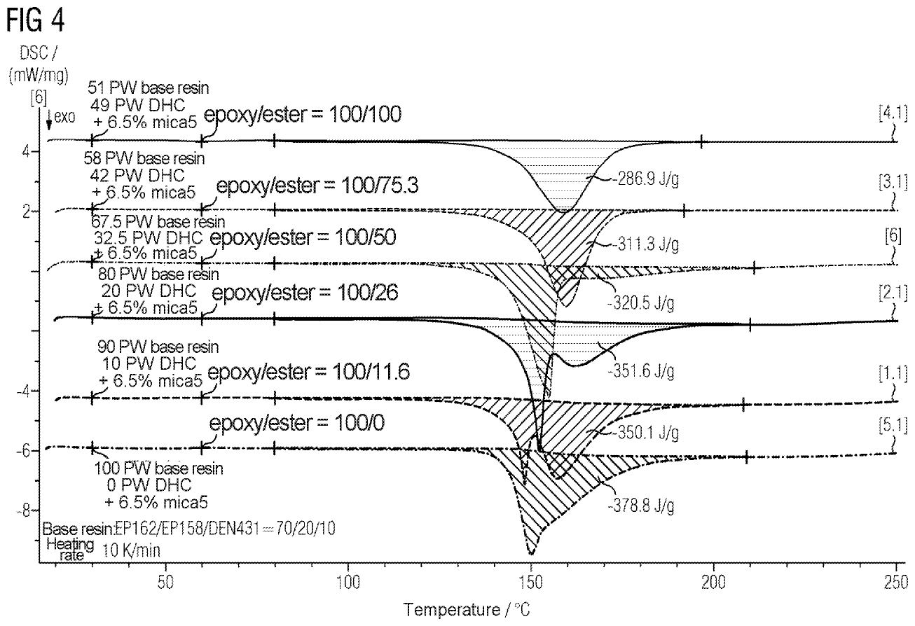

FIG. 4 shows the DSC scans of the crosslinking reaction of blends of a resin containing epoxy groups with rising stoichiometric proportions of a linear phenyl carboxylate, illustrated here by the example of bisphenol A acetate propionate, at a high concentration of curing catalyst of 6.5% by weight of an anionic curing catalyst. The scan shown in FIG. 1 shows the evaluation of the exothermicities of reaction.

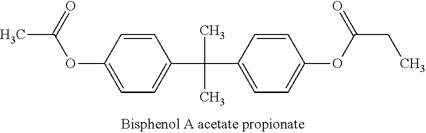 [SMILES: CCC(=O)Oc1ccc(C(C)(C)c2ccc(OC(C)=O)cc2)cc1]

The 6 graphs shown in FIG. 4 show the DSC scans of mixtures of resin containing epoxy groups and the linear phenyl carboxylate which is difunctional because it has two ester groups, at high concentration of an anionic curing catalyst and with rising stoichiometric proportions of phenyl carboxylate.

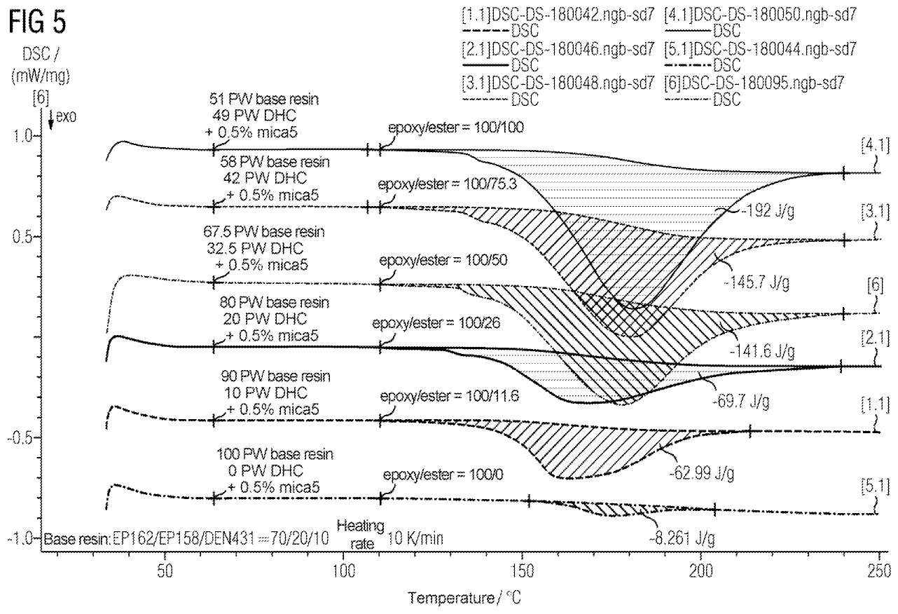

FIG. 5 shows the same DSC measurements of a blend of a resin containing epoxy groups with rising stoichiometric proportions of a linear phenyl carboxylate, again with bisphenol A acetate propionate, at a low concentration of curing catalyst of 0.5% by weight of an anionic curing catalyst. The scan shown in FIG. 5 shows the evaluations of the exothermicities of reaction that are comparable to FIG. 4.

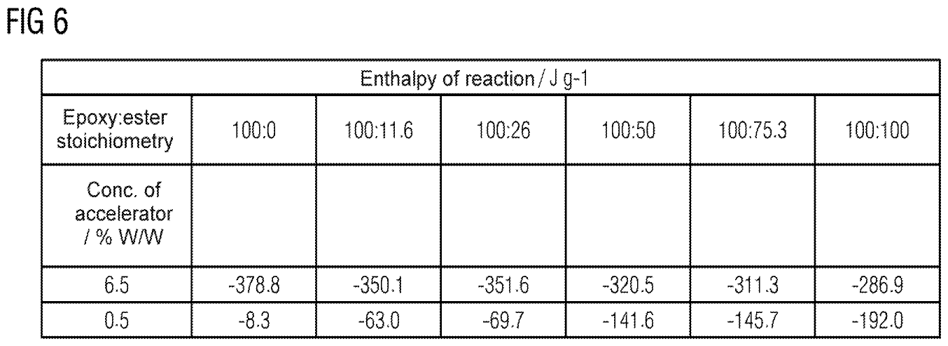

FIG. 6 summarizes the results from FIGS. 4 and 5, it being apparent that, even in the case of stoichiometric proportions of 50% phenyl carboxylate additive, it is possible to achieve a distinct rise in the exothermicity of reaction even in the case of small accelerator concentrations, and that there is a decrease in the difference in the exothermicities of reaction, especially in the comparison of high and low accelerator concentration.

FIG. 6 shows a table which summarizes how the enthalpies of reaction of mixtures of epoxy-containing impregnating agents and additive, here bisphenol A acetate propionate, a linear phenyl carboxylate, vary at high and low concentration of a curing catalyst with rising stoichiometric ratio of additive.

It is also apparent, both in FIG. 5, the lowermost graph, and FIG. 6, table, that there is no significant crosslinking, “enthalpy of reaction −8.3”, at the low accelerator concentration without addition of additive, i.e. lowermost line and second column from left. This is evidence that an additive according to the present invention results in a modification of reactivity of the epoxy-containing impregnating agent in regions with low curing catalyst concentration.

The table from FIG. 6 demonstrates clearly that, in the case of stoichiometric proportions of 50% to 75% phenyl carboxylate, it is possible to achieve a distinct rise in the exothermicity of reaction even in the case of small accelerator concentrations. There is also a decrease in the differences in the exothermicities of reaction, apparent from the comparison of high and low accelerator concentration.

Accordingly, an anhydride-free impregnating agent comprising at least one or a plurality of epoxides, for example selected from the group of the glycidyl ethers, novolaks, cycloaliphatic epoxy resins and/or epoxidized silicones and/or siloxanes, with one or more phenyl carboxylates as additive, especially with one or more phenyl carboxylates of the structures I to VI shown below, for modification of the reactivity of the impregnating agent with respect to low curing catalyst concentrations in the case of use in the VPI process for impregnation of a solid insulation material with an incorporated curing catalyst, will undergo better complete curing to give a thermoset than an impregnating agent without additive. This effect of the additive is observable irrespective of the presence of a curing catalyst in the impregnating agent.

The additive according to the present invention is present in the impregnating agent at least at 0.1% based on the stoichiometry. For example, it is present in a concentration—based on the stoichiometry with regard to the epoxy groups—of 0.1% to 100%, especially of 10% to 100%, preferably in the range from 50% to 100% and especially preferably in the range from 75% to 100%.

In some embodiments, the additive takes the form of a compound of one or more of the following structures:

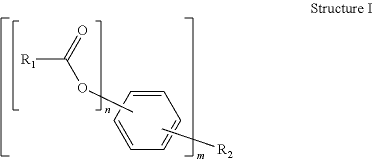

with n in the range from 1 to 5, n=1-5;

m in the range from 1 to 10, m=1-10;

R¹/R²=identical or different and

selected from the group of the following radicals

R¹=
H,
alkyl, linear or branched or cyclic with 1 to 12 carbon atoms, or
aryl having 6 to 12 carbon atoms, with or without side chains;

R²=
H,
alkyl, linear or branched or cyclic with 1 to 12 carbon atoms,
aryl having 6 to 12 carbon atoms
sulfonyl
sulfate
phosphonyl
phosphate or
siloxane, linear or branched or cyclic with 1 to 50 Si—O units.

Siloxanes are compounds having the general formula R₃Si—[OSiR₂]ₓ—O—SiR₃.

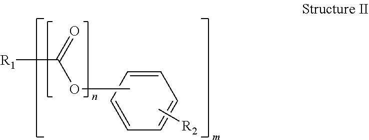

with

n in the range from 1 to 5, n=1-5;

m in the range from 1 to 10, m=1-10;

R¹/R²=identical or different and

selected from the group of the following radicals

R¹=
H,
alkyl, linear or branched or cyclic with 1 to 12 carbon atoms, or
aryl having 6 to 12 carbon atoms, with or without side chains;

R²=Π,
alkyl, linear or branched or cyclic with 1 to 12 carbon atoms, or
aryl having 6 to 12 carbon atoms in the aromatic system, with or without side chains;
acyl.

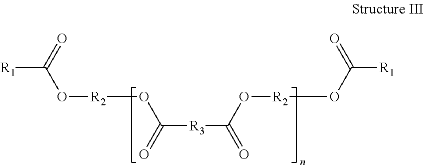

where

n is in the range from 1 to 10, n=1-10;

R¹/R²=identical or different and selected from the group of the following radicals

R¹=
H,
alkyl, linear or branched or cyclic with 1 to 12 carbon atoms, or
aryl having 6 to 12 carbon atoms, with or without side chains;

R²=
aryl having 6 to 12 carbon atoms in the aromatic system,
alkylaryl having 2 to 4 phenyl units
biphenyl

R³=absent or
alkyl, linear or branched or cyclic with 1 to 12 carbon atoms, or
aryl having 6 to 12 carbon atoms in the aromatic system;
alkylaryl having 2 to 4 phenyl units
biphenyl.

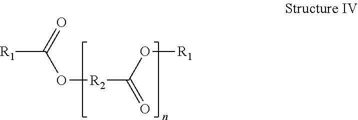

where

n is in the range from 1 to 10, n=1-10;

R²=identical or different and

selected from the group of the following radicals

R²=
H,
alkyl, linear or branched or cyclic with 1 to 12 carbon atoms, or
aryl having 6 to 12 carbon atoms, with or without side chains;

R²=
aryl having 6 to 12 carbon atoms in the aromatic system,
alkylaryl having 2 to 4 phenyl units
biphenyl.

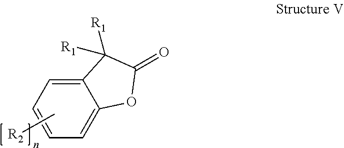

where

n is in the range from 1 to 10, n=1-10;

R²=identical or different and

selected from the group of the following radicals

R¹=
H,
alkyl, linear or branched or cyclic with 1 to 12 carbon atoms, or
aryl having 6 to 12 carbon atoms, with or without side chains;

R²=
aryl having 6 to 12 carbon atoms in the aromatic system,
alkylaryl having 2 to 4 phenyl units
biphenyl
acyl
carboxyl.

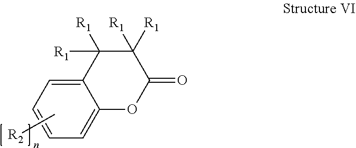

where

n is in the range from 1 to 10, n=1-10;

R²=identical or different and

selected from the group of the following radicals

R¹=
H,
alkyl, linear or branched or cyclic with 1 to 12 carbon atoms, or
aryl having 6 to 12 carbon atoms, with or without side chains;

R²=
aryl having 6 to 12 carbon atoms in the aromatic system,
alkylaryl having 2 to 4 phenyl units
biphenyl
acyl
carboxyl.

Specified hereinafter are illustrative embodiments of the invention with specific reference to compounds having structural formulae:

### Examples Derived from Parent Structure I

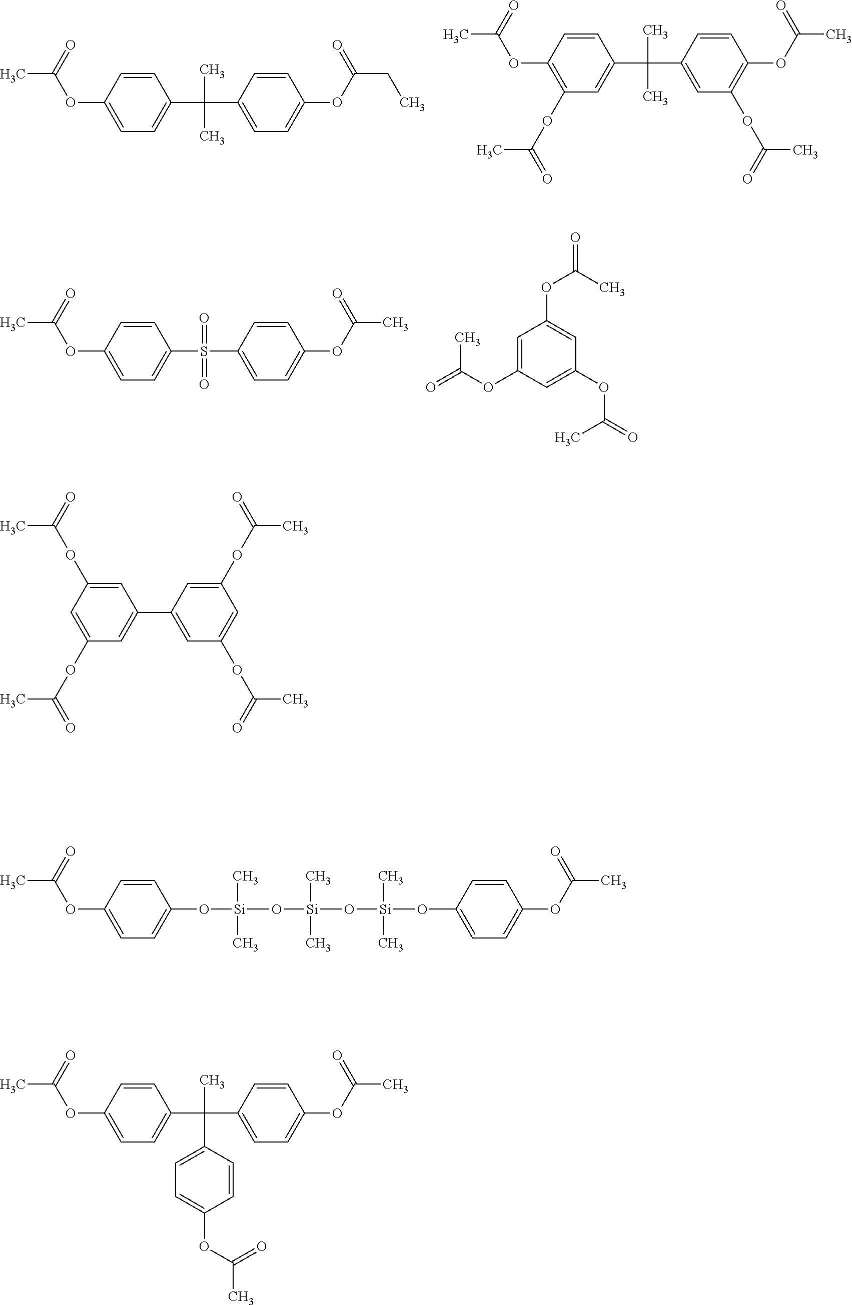

### Example Derived from Parent Structure II

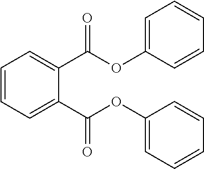 [SMILES: O=C(Oc1ccccc1)c1ccccc1C(=O)Oc1ccccc1]

### Example Derived from Parent Structure V

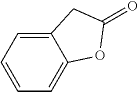

### Example Derived from Parent Structure VI

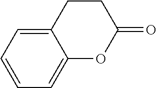 [SMILES: O=C1CCc2ccccc2O1]

The phenyl carboxylates disclosed here for the first time as additives for epoxy-containing impregnating agents, even in anhydride-free impregnating agents, when used in the VPI process for impregnation of solid insulation materials with incorporated curing catalysts, in regions with low curing catalyst concentration, i.e. in regions of the insulation remote from the depot, enable sufficient reactivity for curing to give the thermoset and hence for molding material formation.

What is claimed is:

1. A solid insulation material based on a resin containing epoxy groups for production of an anhydride-free insulation system by means of VPI, the material comprising:
an anhydride-free curing catalyst; and
an additive for improving distribution of the anhydride-free curing catalyst, wherein the additive comprises a
phenyl carboxylate;
wherein the additive is present in an amount based on the epoxy groups in the resin containing epoxy groups which is present in the impregnating agent of at least 0.1% in stoichiometric terms.

2. The solid insulation material as claimed in claim 1, wherein the phenyl carboxylate is a compound of the following general structure I: 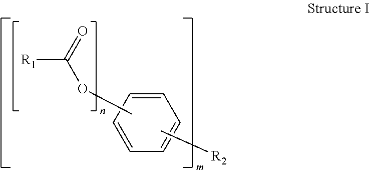
with n in the range from 1 to 5, n=1-5;
m in the range from 1 to 10, m=1-10;
R¹/R²=identical or different and
selected from the group of the following radicals
R¹=
H,
alkyl, linear or branched or cyclic with 1 to 12 carbon atoms, or
aryl having 6 to 12 carbon atoms, with or without side chains;
R²=
H,
alkyl, linear or branched or cyclic with 1 to 12 carbon atoms,
aryl having 6 to 12 carbon atoms
sulfonyl
sulfate
phosphonyl
phosphate or
siloxane, linear or branched or cyclic with 1 to 50 Si—O units.

3. The solid insulation material as claimed in claim 1, wherein the phenyl carboxylate is a compound of the following general structure II: 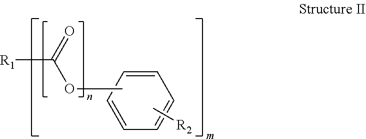
with
n in the range from 1 to 5, n=1-5;
m in the range from 1 to 10, m=1-10;
R¹/R²=identical or different and
selected from the group of the following radicals
R¹=
H,
alkyl, linear or branched or cyclic with 1 to 12 carbon atoms, or
aryl having 6 to 12 carbon atoms, with or without side chains;
R²=Π,
alkyl, linear or branched or cyclic with 1 to 12 carbon atoms, or
aryl having 6 to 12 carbon atoms in the aromatic system, with or without side chains;
acyl.

4. The solid insulation material as claimed in claim 1, wherein the phenyl carboxylate is a compound of the following general structure III: 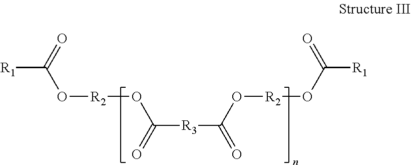
where
n is in the range from 1 to 10, n=1-10;
R¹/R²=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
R³=absent or
alkyl, linear or branched or cyclic with 1 to 12 carbon atoms, or
aryl having 6 to 12 carbon atoms in the aromatic system;
alkylaryl having 2 to 4 phenyl units biphenyl.

5. The solid insulation material as claimed in claim 1, wherein the phenyl carboxylate is a compound of the following general structure IV: 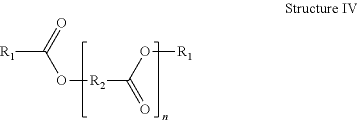
where
n is in the range from 1 to 10, n=1-10;
R¹=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl.

6. The solid insulation material as claimed in claim 1, wherein the phenyl carboxylate is a compound of the following general structure V: 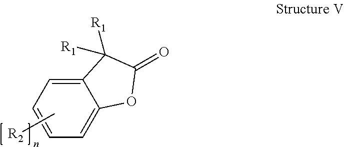
where
n is in the range from 1 to 10, n=1-10;
R¹=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
acyl
carboxyl.

7. The solid insulation material as claimed in claim 1, wherein the additive phenyl carboxylate is a compound of the following general structure VI: 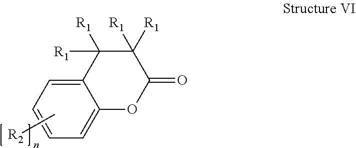
where
n is in the range from 1 to 10, n=1-10;
R¹=identical or different and
selected from the group of the following radicals
R¹=
H,
alkyl, linear or branched or cyclic with 1 to 12 carbon atoms, or
aryl having 6 to 12 carbon atoms, with or without side chains;
R²=
aryl having 6 to 12 carbon atoms in the aromatic system,
alkylaryl having 2 to 4 phenyl units
biphenyl
acyl
carboxyl.

8. The solid insulation material as claimed in claim 1, wherein the phenyl carboxylate is selected from the group consisting of:

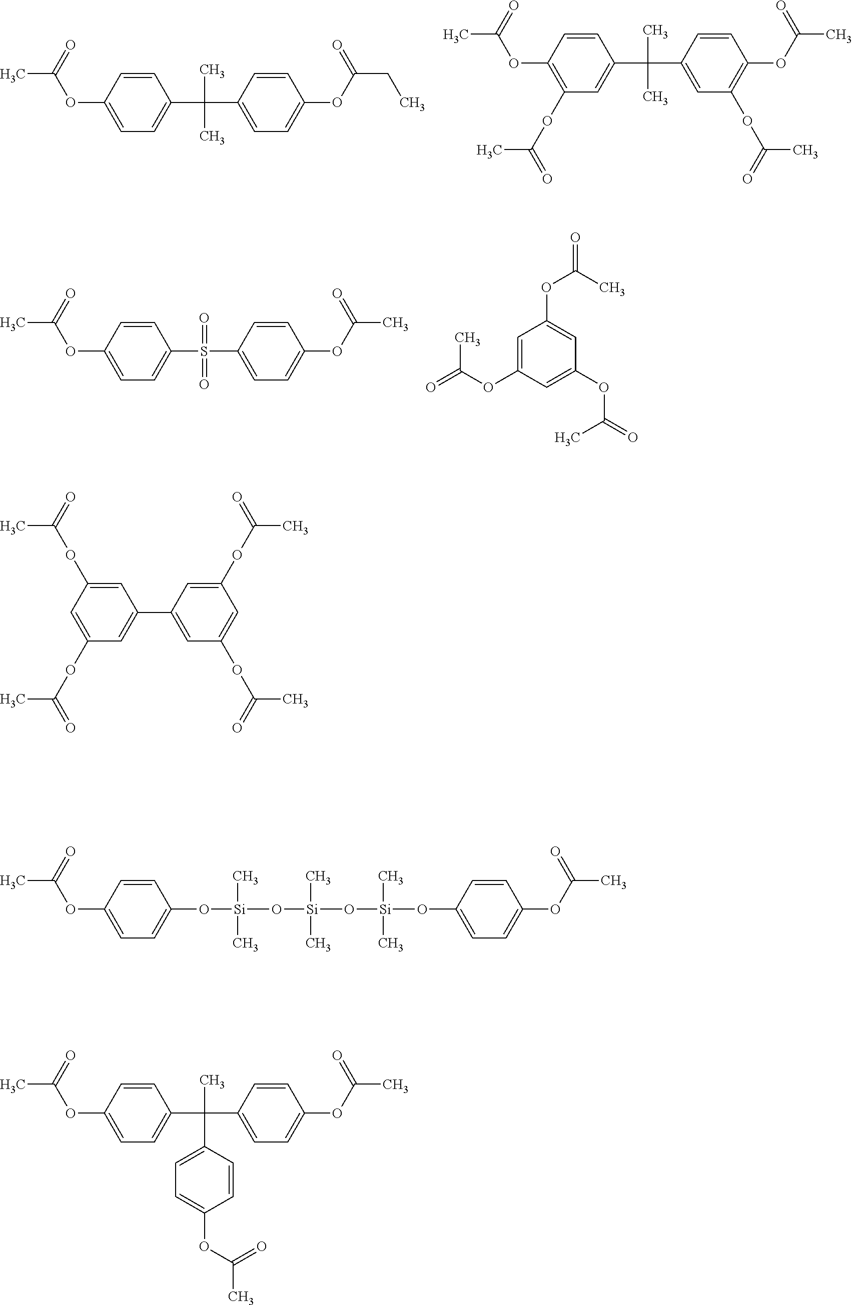

9. The solid insulation material as claimed in claim 1, wherein the phenyl carboxylate is selected from the group consisting of:

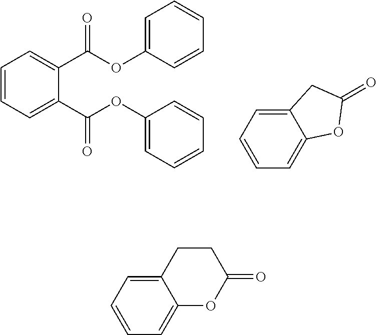

10. The solid insulation material as claimed in claim 1, wherein the additive, based on the epoxy groups in the resin containing epoxy groups which is present in the impregnating agent, is present in an amount in the range from 10% to 100% in terms of stoichiometry.

11. The solid insulation material claimed in claim 1, wherein the additive, based on the epoxy groups in the resin containing epoxy groups which is present in the impregnating agent, is present in an amount in the range from 50% to 100% in terms of stoichiometry.

12-13. (canceled)

14. An insulation system for an electrical rotating machine, the system comprising:
solid insulation material based on a resin containing epoxy groups for production of an anhydride-free insulation system by means of VPI, the material comprising:
an anhydride-free curing catalyst;
and additive for improving distribution of the anhydride-free curing catalyst, wherein the additive comprises a phenyl carboxylate;
wherein the additive is present in an amount based on the epoxy groups in the resin containing epoxy groups which is present in the impregnating agent of at least 0.1% in stoichiometric terms.

15. An electrical machine with an insulation system as claimed in claim 14.
